(19) United States
(12) Patent Application Publication
(10) Pub. No.: US 2016/0225249 A1
(43) Pub. Date: Aug. 4, 2016

(54) PROXIMITY MONITOR AND PROCESSOR-IMPLEMENTED PROXIMITY MONITORING METHOD

(71) Applicants: Edward G. Caputo, Naples, FL (US); Michael F. Granata, Naples, FL (US)

(72) Inventors: Edward G. Caputo, Naples, FL (US); Michael F. Granata, Naples, FL (US)

(21) Appl. No.: 14/610,763

(22) Filed: Jan. 30, 2015

(51) Int. Cl. G08B 21/24; H04W 4/02

(52) U.S. Cl. CPC G08B 21/24; H04W 4/023

(57) ABSTRACT

A proximity monitoring system and method involves a mobile device monitoring at least one transponder and determining when the at least one transponder is separated from the mobile device by at least a predefined distance and providing an alert when the predefined distance is exceeded.

### BACKGROUND

1. Field of the Invention

This disclosure relates generally to risk of loss prevention systems and methods and, more particularly, to systems and methods for monitoring predefined items to reduce the risk of their loss.

2. Description of Related Art

Mobile devices, such as smartphones, are becoming an increasingly essential tool for everyday life for more and more people. For many people, such devices have become as important as other items such as wallets, keys, jewelry, watches, laptop computers, tablet computers, and other mobile devices. The increasing number of such items that many people typically have with them during the day can often increase the likelihood that one or more of such items will be misplaced or even lost, especially in view of peoples' increasingly complex and fast-paced lifestyles. Such losses can result in significant inconvenience, including the lost time and effort required to find them, and, in some cases, the irreplaceability or monetary loss if the lost items are not found.

### BRIEF SUMMARY

One aspect of this disclosure involves a proximity monitoring system. The system includes at least one transponder secured to a personal item of a user and configured to emit an identifiable signal having at least a minimum specified strength; an application running on a processor of a mobile device to cause the mobile device to periodically monitor for the identifiable signal of the at least one transponder to determine when a distance between the mobile device and the at least one transponder exceeds a specified distance based upon either (i) receipt of the identifiable signal at a level below a particular signal strength or (ii) non-receipt of the identifiable signal; and when the distance between the mobile device and the at least one transponder exceeds the specified distance the application is configured to cause the mobile device to issue an alert to the user.

Another aspect of this disclosure involves a processor-implemented method for notifying a user if a personal item, having a transponder secured thereto, is missing based on the proximity thereof to a mobile device. The method involves periodically monitoring, using the mobile device, for a distance between the mobile device and the personal item by measuring strength of a signal received by the mobile device that was emitted by the transponder; comparing, using the mobile device, the strength of the received signal to an allowable signal strength corresponding to a maximum allowable distance between the mobile device and the transponder and providing an alert signal to the user if the strength of the received signal, when compared to the allowable signal strength, is less than the allowable signal strength so as to indicate that the distance between the mobile device and the personal item has exceeded a predefined allowable threshold distance.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified form, a representation of a proximity monitoring system implementing the approach described herein;

FIG. 2 illustrates, in simplified form, a representative example graphical user interface (“GUI”) that can be displayed on the screen of a mobile device when an application program (“app”) is running thereon implemented to operate as part of the proximity monitors described herein; and

FIG. 3 illustrates, in simplified form, a representative alternative example GUI for a proximity monitor implemented as described herein.

Corresponding reference characters indicate corresponding parts throughout the several views of the drawings. This disclosure is further described in the detailed description that follows, with reference to the drawings.

### DETAILED DESCRIPTION

In general overview, the proximity monitor and processor-implemented method described herein provide for monitoring of the distance between a user's mobile device and a transponder. By securing the transponder to a personal item of the user, the distance between the personal item and mobile device will be monitored and, if the distance between the personal item and mobile device exceeds some specified distance, an alert will be provided to the user. This increases the likelihood that the user will not travel beyond the specified distance from the personal item (or the personal item will not be moved beyond that distance from the user) since such mobile devices are routinely kept close to their users. As a result, the likelihood of loss of such personal items, for example, through misplacement, is reduced and the possibility of quick alert to theft is increased. This is very beneficial since such personal items may include (but are not limited to) wallets, keys, jewelry, watches, laptop computers, tablet computers, and other mobile devices.

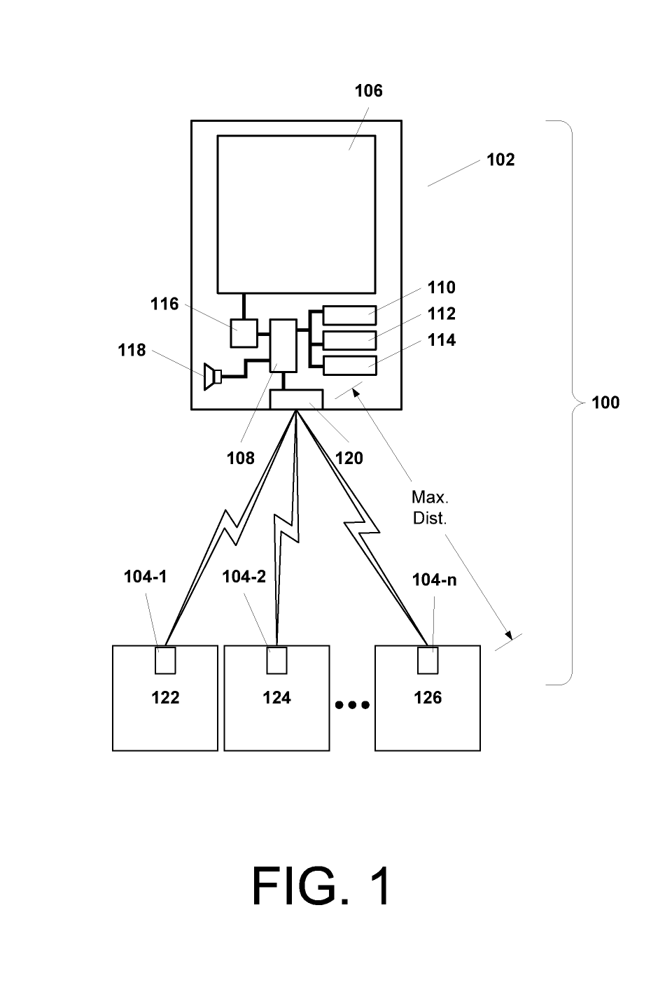

With the above in mind, FIG. 1 illustrates, in simplified form, a representation of a proximity monitoring system 100 implementing the approach described herein. The system is made up of a proximity monitoring receiver in the form of a mobile device 102, for example, a smartphone, or some other device capable of operating as described herein, and at least one (and likely more) transponder(s) 104-1, 104-2, . . . 104-n.

The mobile device 102 includes an externally visible screen 106 on which a graphical user interface (“GUI”) can be displayed containing information related to, among other things, the transponders 104-1 104-2, . . . 104-n. Depending upon the particular implementation, this information may be displayed by icons, text or some combination thereof. Ideally, the screen 106 is a touch screen, which allows the user to provide input by directly touching the screen 106. Alternatively, or additionally, the mobile device may contain a keyboard via which user input can be provided. Internally, the mobile device 102 includes at least one processor 108 coupled to RAM 110, ROM 112 and non-transient storage 114 into which application programs and data may be stored and retrieved for execution and use. In addition, the mobile device includes circuitry 116 that, for example, converts user input via the screen to a form usable by the processor 108, implements cell phone capability, and/or implements other operational aspects commonly found in smartphones, the additional operational aspects being irrelevant to understanding the instant invention. Finally, the mobile device 102 includes appropriate transceiver circuitry 120 to allows it to wirelessly communicate with, for example, the transponders 104-1, 104-2, . . . 104-n, for example, using low power radio frequency (“RF”) signals, generally within the Industrial, Scientific and Medical (“ISM”) radio bands defined by the ITU Radiocommunication Sector (“ITU-R”) in 5.138, 5.150, and 5.280 of the Radio Regulations as adopted by the World Radiocommunication Conference.

The transceiver circuitry 120 wirelessly communicates with the transponders 104-1, 104-2, . . . 104-n using an appropriate protocol, standard or proprietary.

The transponders 104-1, 104-2, . . . 104-n are constructed to be small and easily affixed to those personal items 122, 124, 126 that the user wishes to maintain in their close proximity and, thus, have monitored. In the simplest implementation, the transponders are self-powered with a battery and configured to receive a signal from the transceiver circuitry and issue a signal, at a particular signal strength, that allows it to uniquely identify itself. It is understood that the term “unique” as used herein is intended to merely mean unique relative to the other transponders 104-1, 104-2, . . . 104-n that the user may also be using on other of their personal items so that they can be differentiated, and not universally unique. Depending upon the particular implementation, the uniquely identifying signal can be as simple as a unique number or a more complex identifier.

The transponders 104-1, 104-2, . . . 104-n may be constructed, depending upon implementation, to continually emit its signal, to periodically emit its signal, or to monitor for receipt of a signal from the transceiver and respond with its identifier.

Since it is well known that signal strength weakens according to the inverse square law, meaning that the signal strength is inversely proportional to the square of the distance from the source, a doubling of the distance between the transponders 104-1, 104-2, . . . 104-n and the transceiver 120 of the mobile device 102 will result in a signal that is ¼ as strong, the tripling of the distance will result in a signal that is 1/9 as strong. Likewise, halving the distance between the transponders 104-1, 104-2, . . . 104-n and the transceiver 120 of the mobile device 102 will result in a signal 4× as strong as was received at the starting point. As such, the transponders 104-1, 104-2, . . . 104-n are constructed to emit a signal of sufficient strength to be received by the transceiver 120 of the mobile device 102 at a maximum separation distance of up to about 40 to about 50 feet (about 12 to about 15 meters).

Thus, depending upon the particular implementation, when the distance between a transponder 104-1, 104-2, . . . 104-n and the transceiver 120 of the mobile device 102 exceeds that maximum separation distance, the transceiver 120 of the mobile device 102 will either not receive the signal at all or it will receive an attenuated signal whose strength is indicative of a distance in excess of that distance. In addition, with some implementations, since the received strength of the signal from a transponder 104-1, 104-2, . . . 104-n can be used to roughly determine its distance from the transceiver 120 of the mobile device 102, a user can be allowed to specify a separation distance that is less than the maximum. In such implementations, programming of the mobile device 102 and its transceiver 120 will either (i) calculate an expected signal strength from the user-specified distance and compare the strength of the received signal to it, or (ii) based upon the received signal strength, calculate a corresponding distance and compare that calculated distance to the user-specified separation distance. Either way, if the result of the calculation is an indication that the specified distance has been exceeded, programming in the mobile device 102 will cause an alert to be issued to the user.

Depending upon the particular implementation, the alert can be an audible alert issued through the speaker(s) 118, it can be a visual alert displayed on the screen 106, for mobile devices 102 that include a vibration capability, the alert could be a vibratory pattern, or the alert could be some combination thereof In addition, the mobile device 102 may cause the transponder 104-1, 104-2, . . . 104-n to provide an audible, vibratory and/or visual alert.

Having described representative hardware components of the proximity monitoring system, the operation from a user perspective will now be described.

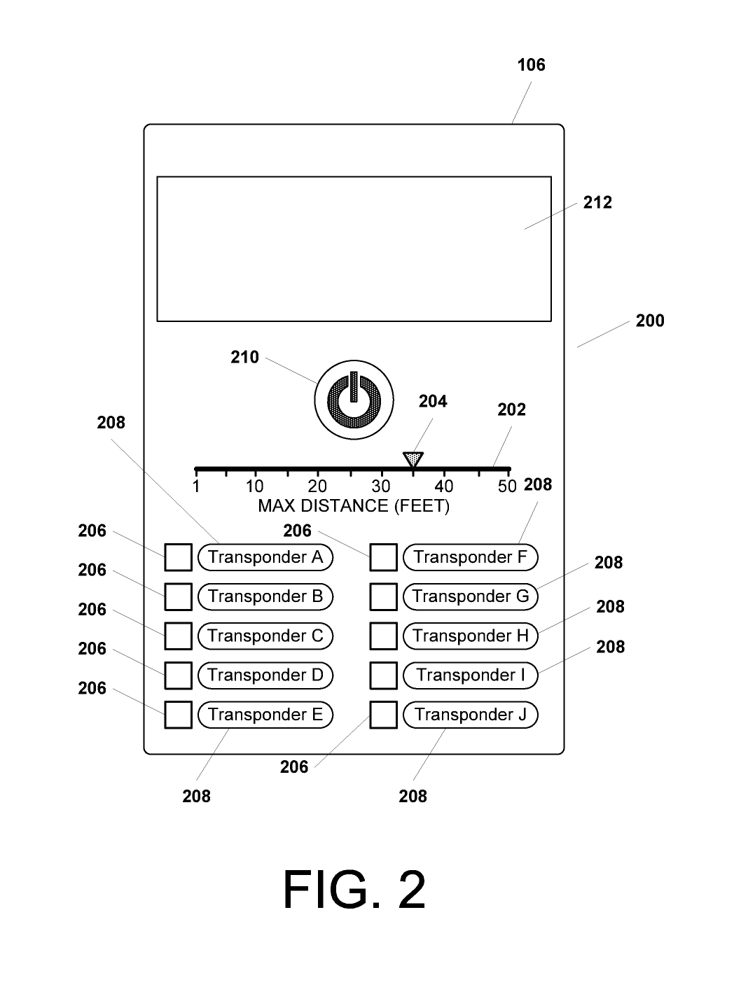

FIG. 2 illustrates, in simplified form, a representative example graphical user interface (“GUI”) 200 that can be displayed on the screen 106 of the mobile device 102 when the application program (“app”) is running thereon. As shown, the GUI 200 includes a slider 202 within which a user can specify a maximum separation distance between the mobile device 102 and a transceiver 104 by moving a pointer 204 to the desired maximum separation distance to be allowed. The GUI 200 also includes a series of check boxes 206 that can be selected or de-selected to indicate whether the associated transponder should be monitored. As shown, the GUI 200 is further configured to allow a user to associate in the GUI 200 a particular personal item with a particular transponder by, for example, touching a part 208 of the screen 106 corresponding to that particular transponder (labeled “Transponder A” through “Transponder J”) that is attached to that item, at which point, depending upon the particular implementation, a list of personal item types can be displayed or keyboard entry can be provided by the user to enter some form of identifier for the item. In the list example, a list of common personal item types, for example, Wallet, Backpack, Briefcase, Purse, Laptop, Tablet, Jewelry (or more specific terms, like Watch, Necklace, etc.), Stuffed Animal, Pet (live), Book, etc.

Advantageously, in addition to being able to select the particular personal item(s) to be monitored, a user is not required to monitor the selected item(s) all the time. Thus, as shown, the GUI 200 includes an area 210 configured as an “On/Off” button which, when set to “On” causes the selected transponders to be monitored and, when set to “Off” precludes monitoring of any transponders, irrespective of whether or not they have been selected in the GUI 200.

Additionally, some variants of the GUI 200 may include one or more areas 212 where additional information can be displayed, for example, a company or a sponsor's logo, advertisements, alerts, etc.

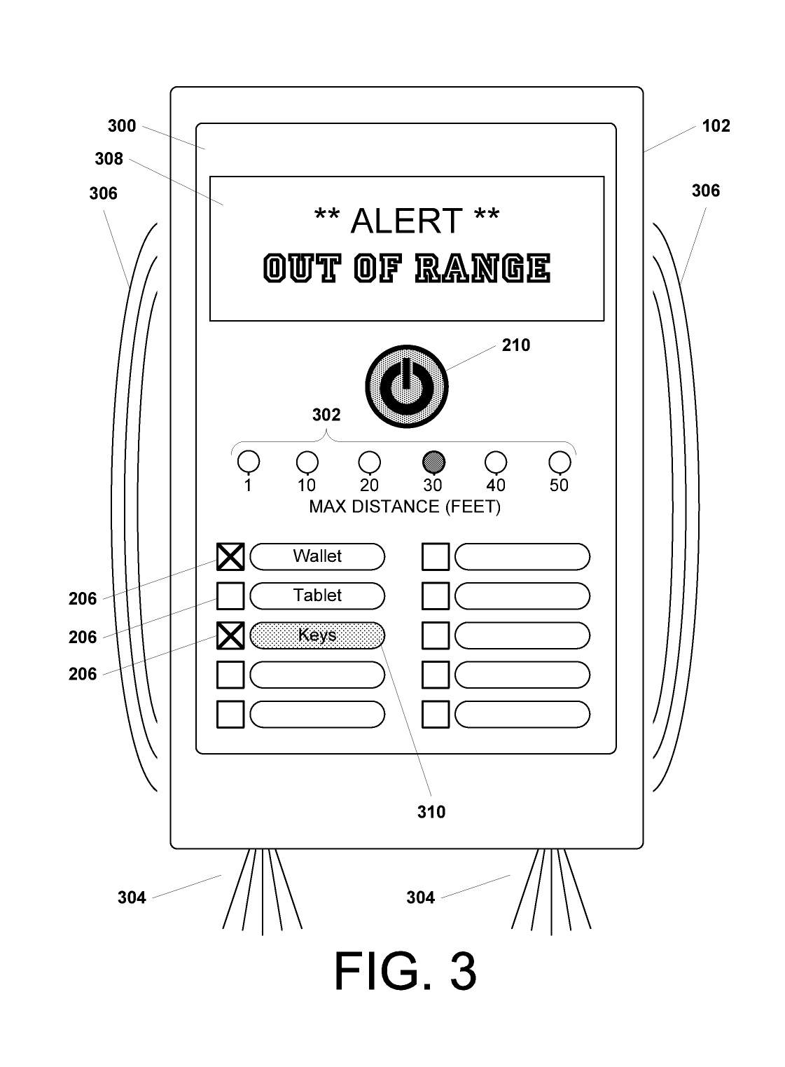

With the foregoing as background, a usage example will now be discussed to provide context for the foregoing with reference to FIG. 3.

FIG. 3 illustrates, in simplified form, a representative alternative example GUI 300 for a proximity monitor system 100 implemented as described herein.

For purposes of the example of FIG. 3, presume that a user has an implementation variant proximity monitoring system in use. To do so, they have installed the appropriate application program on their mobile device 102 and affixed transponders to their wallet, a tablet computer and their keys. Consequently, they have associated those items with the respective transponders in the GUI 300 and, using the check boxes, selected only the wallet and keys for monitoring. In addition, the user has specified the maximum allowable separation distance between the transponders and mobile device, in this interface, using the “radio button” representations 302 on the GUI 300 to a distance of 30 feet. Finally, presume that the user is in a restaurant and has left their keys on the table.

Since the application is running, periodically (which could be every second, every minute, a certain number of times per minute), the transceiver 120 in the mobile device 102 checks for the presence of the selected two monitored transponders that are respectively coupled to the user's wallet and keys. Upon receipt of the signal from each, the application determines if the transponders are both within the specified distance based upon the received signal strength. During the entire meal, they are both within 30 feet of the mobile device 102, so all is well.

At the end of the meal, the user gets up from the table and does not notice that their keys are still on the table covered by a napkin. As the user heads towards the door, the distance between the transponders attached to the keys and the mobile device 102 increases until, at some point, the signal received by the transceiver 120 from the transponder attached to the keys drops such that the distance between the two exceeds the specified 30 feet. As a result, the application immediately triggers an alert for the user. As shown with this implementation example, the alert is made up of an audible alert tone 304 provided through the mobile device speakers, a physical vibratory alert 306 and a visual alert 308 in the GUI 300 displayed on the screen 106 of the mobile device 102. Moreover, since the application knows which transponder is beyond the distance, an indication of that is optionally provided as well, in this case by highlighting the area 310 for that transponder labeled “Keys.” Thus, before they have gone too far, the user can return to the table and retrieve their keys.

Having described and illustrated the principles of this application by reference to one or more preferred embodiments, it should be apparent that the preferred embodiment(s) may be modified in arraignments and detail without departing from the principles disclosed herein and that it is intended that the application be construed as including all such modifications and variations insofar as they come within the spirit and scope of the subject matter disclosed herein.

What is claimed is:

1. A proximity monitoring system, comprising:
at least one transponder secured to a personal item of a user and configured to emit an identifiable signal having at least a minimum specified strength;
an application running on a processor of a mobile device to cause the mobile device to periodically monitor for the identifiable signal of the at least one transponder to determine when a distance between the mobile device and the at least one transponder exceeds a specified distance based upon either (i) receipt of the identifiable signal at a level below a particular signal strength or (ii) non-receipt of the identifiable signal; and
when the distance between the mobile device and the at least on transponder exceeds the specified distance, the application is configured to cause the mobile device to issue an alert to the user.

2. The proximity monitoring system according to claim 1, further comprising:
a graphical user interface (GUI) viewable on the mobile device, the graphical user interface (GUI) displaying information related to a user-specified maximum allowable distance between the at least one transponder and the mobile device.

3. The proximity monitoring system according to claim 2, wherein the information is used to determine an acceptable in-range signal strength level.

4. The proximity monitoring system according to claim 2, wherein:
the graphical user interface (GUI) is configured to allow the user to identify the at least one transponder from among multiple transponders each having a particular identifiable signal.

5. The proximity monitoring system according to claim 1, wherein:
the at least one transponder is one of multiple transponders each secured to different personal items and, wherein the multiple transponders are each configured to emit different identifiable signals.

6. The proximity monitoring system according to claim 4, wherein:
the graphical user interface (GUI) is configured to allow the user to identify at least two of the multiple transponders for monitoring, such that the mobile device will monitor for at least two of the different identifiable signals and issue an alert when any of the identified at least two of the multiple transponders is beyond the specified distance from the mobile device.

7. A processor-implemented method for notifying a user if a personal item, having a transponder secured thereto, is missing based on the proximity thereof to a mobile device, comprising:
periodically monitoring, using the mobile device, for a distance between the mobile device and the personal item by measuring strength of a signal received by the mobile device that was emitted by the transponder;
comparing, using the mobile device, the strength of the received signal to an allowable signal strength corresponding to a maximum allowable distance between the mobile device and the transponder; and
providing an alert signal to the user if the strength of the received signal, when compared to the allowable signal strength, is less than the allowable signal strength so as to indicate that the distance between the mobile device and the personal item has exceeded a predefined allowable threshold distance.

8. The method according to claim 7, wherein the transponder is one of multiple transponders each secured to different respective personal items, and wherein the monitoring comprises:
performing the comparing for each of the multiple transponders, and wherein the providing comprises providing the alert signal to the user when any received signal strength, when compared to the allowable signal strength, is less than the allowable signal strength.

9. The method according to claim 8, wherein the multiple transponders each respectively emits a signal that is different from all of the others of the multiple transponders such that the mobile device can distinguish among the multiple transponders.

10. The method according to claim 8, further comprising:
securing an individual one of the multiple transponders to an individual one of the different personal items.

11. The method according to claim 10, wherein the mobile device has a graphical user interface (GUI), the method further comprising:
varying which of the multiple transponders are monitored by changing a setting in the GUI.

12. The method according to claim 11, further comprising:
causing monitoring of a first transponder by making a selection in the GUI.

13. The method according to claim 11, further comprising:
causing monitoring of a currently monitored first transponder to cease by making a selection in the GUI.

14. The method according to claim 11, wherein the mobile device has a graphical user interface (GUI), the method further comprising:
displaying, via the graphical user interface (GUI), an indication of which of the personal items to which the transponders are secured are being monitored.

15. The method according to claim 7, wherein the mobile device has a graphical user interface (GUI), the method further comprising:
providing, via the GUI, an ability to vary the predefined threshold.

16. The method according to claim 15, wherein the ability to vary allows a user to specify the predefined threshold as a particular value of between about 1 foot and about 40 feet.

17. The method according to claim 9, wherein the providing the alert signal comprises:
issuing an audible signal.

18. The method according to claim 9, wherein the providing the alert signal comprises:
issuing a visual signal on the mobile device.

19. The method according to claim 9, wherein the providing the alert signal comprises:
causing the mobile device to vibrate.
